(19) United States
(12) Patent Application Publication
(10) Pub. No.: US 2026/0055014 A1
(43) Pub. Date: Feb. 26, 2026

(54) FLEXIBLE MOBILE WATER TREATMENT SYSTEM

(71) Applicant: BRIDGEWATER DESIGN INC., Guelph (CA)

(72) Inventor: Fraser Charles KENT, Guelph (CA)

(21) Appl. No.: 19/304,128

(22) Filed: Aug. 19, 2025

Related U.S. Application Data
(60) Provisional application No. 63/685,031, filed on Aug. 20, 2024.

(51) Int. Cl. C02F 1/44; C02F 1/68

(52) U.S. Cl. CPC C02F 1/444; C02F 1/441; C02F 1/68; C02F 2201/004; C02F 2201/005; C02F 2201/008; C02F 2209/006

(57) ABSTRACT

This specification describes a flexible (i.e. configurable) mobile water treatment system, various components of such a system, and a method of configuring a mobile water treatment system. One part of the system includes a shipping container having common equipment. Another part of the system includes a set of one or more skids available to be selectively mounted in the shipping container and connected to the common equipment. The set may include two or more of the same type of skid and/or two or more different types of skids. A process includes mounting one or more skids in the container and connecting the one or more skids to the common equipment. A skid may have, for example, reverse osmosis, ultrafiltration, nanofiltration, microfiltration, depth filtration, green sand filtration, activated carbon treatment, ion exchange, or other treatment equipment.

### RELATED APPLICATIONS

This application claims the benefit of, and priority from, U.S. Provisional Application No. 63/685,031, filed on Aug. 20, 2024, which is incorporated by reference.

### FIELD

This specification relates to mobile water treatment systems and processes.

### INTRODUCTION

The following introduction is not admission that anything described below is citable prior art.

WO 2014/049430, entitled Mobile water filtration unit and control system, and related devices, components, systems and methods, describes a mobile water treatment unit based on a standardized container. The unit can be customized to include treatment modules for treating a given water type. The treatment modules, control units, and remote monitoring equipment are all mounted to a rigid frame that can be removed from the container.

WO 2020/245625, entitled Module of a system for filtering liquids, preferably water, and method for filtering a liquid, describes a system for filtering water including multiple modules connected together and inserted into a container. A diverting means can be used to change the configuration of the connection between the modules.

### SUMMARY

This specification describes a mobile water treatment system, various components of such a system, and a method of providing a mobile water treatment system.

In some embodiments, a mobile water treatment system includes one or more shipping containers, each with common equipment. The common equipment can include, for example, a water storage sub-system, a clean-in-place sub-system and/or a compressed air supply sub-system. The mobile water treatment system also includes a set of one or more skids. Each skid may be selectively mounted in the shipping container and connected to the common equipment. A set of skids may include two or more of the same skid and/or skids of different types. The set may include, for example, skids having ultrafiltration equipment, reverse osmosis equipment, microfiltration equipment, nanofiltration equipment, depth filtration equipment, media filtration equipment, green sand filtration equipment, activated carbon treatment equipment, ion exchange treatment equipment or other treatment equipment.

In some aspects, a water treatment apparatus includes a shipping container with common equipment mounted in a first end of the container and two or more receivers extending lengthwise in a second end of the container. Each of the two or more receivers may include a track. The common equipment may include one or more of a water storage tank, a tank in communication with a chemical doing system, and a programmable logic controller (PLC) wherein the PLC is encoded with operating programs for multiple water treatment operations. The water treatment apparatus may two or more feed water inlets and two or more product water outlets. The water treatment apparatus may have an internal valved connection between one of the product water outlets and one of the feed water inlets.

In some aspects, a water treatment system includes a shipping container having common equipment mounted in a first end of the container and one or more water treatment skids. The shipping container selectively receives the one or more treatment skids within the container for connection to the common equipment. The water treatment system may also have a training facility skid. The water treatment system may have two or more water treatment skids which may each include the same type of separation unit or different types of separation units, optionally two or more of media filtration, ultrafiltration, reverse osmosis, ion exchange, activated carbon sorption, ion exchange and green sand filtration. The water treatment system may be configured to connect two or more water treatment skids to provide sequential pretreatment and polishing treatment types. The water treatment system may be configured to connect two water treatment skids in series to provide sequential treatment, optionally ultrafiltration/RO; media filtration/RO; media filtration/UF; RO/IX; ultrafiltration/GAC; or green sand filtration/RO. The common equipment may include valves and pipes configurable to connect two water treatment skids in series or parallel. The common equipment may include a water storage tank, optionally with valves and pipes configurable to connect two water treatment skids in series through the water storage tank. The common equipment may include a PLC configured with operating programs for the one or more water treatment skids. The PLC may also be configured for user input of a treatment type parameter for the one or more water treatment skids.

In some aspects, a method of providing a mobile water treatment unit includes providing a shipping container having common equipment mounted in a first end of the container, placing one or more selectable treatment skids in a second end of the container, and connecting the one or more treatment skids to the common equipment. The method can also cleaning a water treatment skid from the common equipment. The method can include placing two or more water treatment skids in the second end of the container. The method can include placing two water treatment skids each having the same type of separation unit in the second end of the container and connecting the two water treatment skids to the common equipment in parallel. The method can include placing two water treatment skids in the second end of the container, each comprising a different type of separation unit, and connecting the two water treatment skids to the common equipment in series. The method can include connecting a treated water tank of the common equipment in series between the different types of separation unit. A separation unit can provide, for example, media filtration, ultrafiltration, reverse osmosis, ion exchange, activated carbon sorption, ion exchange and green sand filtration. Different types of separation unit can be connected to provide sequential treatment, for example ultrafiltration/RO; media filtration/RO; media filtration/UF; RO/IX; ultrafiltration/GAC; or, green sand filtration/RO. The common equipment may include a PLC configured with operating programs for the one or more water treatment skids. The method may include inputting a treatment type parameter for the one or more water treatment skids into the PLC. Optionally, a training facility skid may be placed in the second end of the container. Water may be treated through the common equipment and a first treatment skid. Optionally, the first treatment skid may be replaced with a second treatment skid and water may be treated through the common equipment and the second treatment skid. Optionally, the training facility skid is connected to the common equipment to permit monitoring and/or control of the first treatment skid and any second treatment skid from the training facility skid.

### DRAWINGS

FIG. 1 is a schematic drawing showing available process flows through a mobile water treatment system fitted with an ultrafiltration skid and a reverse osmosis skid.

FIG. 2 is a schematic drawing of an ultrafiltration skid that may be selectively used with a mobile water treatment system.

FIG. 3 is a schematic drawing of a reverse osmosis skid that may be selectively used with a mobile water treatment system.

FIGS. 4, 5 and 6 are schematic drawings of some common equipment of a mobile water treatment system, in particular a water storage sub-system, a clean-in-place (CIP) sub-system and a compressed air supply sub-system.

FIG. 7 is a schematic drawing of a shipping container for a mobile water treatment system having the common equipment of FIGS. 4, 5 and 6, exterior connections, and interior connections, optionally to the skids of FIGS. 2 and 3.

FIG. 8 is a schematic cross sectional view of part of the shipping container of FIG. 7 showing interior connectors.

FIG. 9 to 13 are schematic drawings of a mobile water treatment system fitted with an RO skid and a UF skid, an RO skid only, two RO skids, two UF skids and one UF skid only.

FIGS. 14 and 15 are left side and right side isometric views of a mobile water treatment system having a UF skid and an RO skid.

FIGS. 16 and 17 are isometric views of the mobile water treatment system of FIGS. 14 and 15 with the UF skid or RO skid partially removed from a container.

FIG. 18 shows isometric views of mobile water treatment systems having a training skid and various optional treatment skids.

FIG. 19 shows a receiver of a container and a frame of a skid.

### DETAILED DESCRIPTION

This specification describes a mobile water treatment system. The system includes a shipping container outfitted with various pieces of common equipment and at least one receiver. The system also includes at least one skid.

The shipping container is optionally a standardized container such as an intermodal container (alternatively called a cargo container, sea can or various other names). The shipping container may comply with International Organization for Standardization (ISO) standard 668:2020 or another standard used in shipping by at least one mode of transport (e.g. truck, train or ship) in a geographical area of interest. The terms “shipping” and “shipping container” do not require that the container is placed on a ship or is adapted to being transported ship. Shipping containers may be, for example, about 8 feet (2.4 m) wide; 40 feet (12.19 m) or 53 feet (16.15 m) long; and, 8 feet 6 inches (2.59 m) or 9 feet 6 inches (2.90 m) high. Alternatively other containers may be used but standardized containers have the advantage of being compliant with the international intermodal freight transport system or with another freight transport system used within a geographical area of interest without modification or customization. In the examples shown in the Figures, a 53 foot intermodal container is used.

The common equipment is mounted permanently in the shipping container. The word “permanently” is used here not to mean that the common equipment can never be removed but in the sense that, subject to typically repairs and modifications of similar equipment, most and possibly all of the common equipment will remain in the shipping container for at least an appreciable service life, for example a year or more. Stated alternatively, removing the common equipment in an orderly way (i.e. without destroying the equipment) would require separating individual pieces of equipment from each other and/or take a material amount of time, for example 6 hours or more or a day or more.

A skid, in contrast, is mounted selectively in the shipping container. The word “selectively” is used herein to mean that a skid can be placed into the shipping container or removed from the shipping container using appropriate machinery, for example a winch, forklift, skid steer or excavator, as a whole unit. Typically, the components of the skid are attached to a frame or bed such that moving the frame or bed simultaneously moves all of the components of the skid. Moving a skid into or out of the container may be done, for example, in 3 hours or less.

The receiver may be merely an area on the floor of the container reserved for placement of the skid. Optionally, the floor of the container is a built-up floor that provides a drainage space below the receiver. Optionally, the receiver includes one or more structures, for example a bed, rails, tracks, guides, pads or rollers, that facilitate sliding a skid into and out of a container repeatedly, or reinforce the floor of the container, or both. A mobile water treatment system may be deployed in each instance for a period of time ranging for example from a week to a year and have a service life of 5-20 years, subject to replacement of consumables and particular components with shorter service lives. Accordingly, the receiver is optionally designed to facilitate and withstand for example 10 or more, 20 or more, or 50 or more skid installations.

Shipping containers typically have large doors that expose the entire cross-sectional area of the container at one end of the shipping container. The receiver is preferably at this end of the shipping container, accessible through the large doors. The common equipment may be installed at an opposite end of the shipping container. Optionally, the shipping container may have two or more receivers. In this case, the receivers may be parallel with each other and extend lengthwise along part of the shipping container. Optionally, space for an aisle or walkway may be provided between two receivers. Optionally, space may be provided through the skids for an aisle of walkway across the width of the container, i.e. between doors provided in the sides of the container.

The mobile water treatment system optionally includes multiple skids. The multiple skids may have the same type of water treatment equipment or different types of water treatment equipment. In this case, a container may be selectively fitted with one skid of one type of water treatment equipment only, two or more skids of the same type of water treatment equipment, or one skid of one type of water treatment equipment and one or more other skids with one or more other types of water treatment equipment.

Optionally, a larger system as a whole may include one or more shipping containers outfitted with common equipment and a set of available skids that may be selectively installed in a shipping container. By way of this arrangement, the system can be made available to respond to a variety of temporary water treatment needs, which may range in rate of treatment and treatment processes, without producing completely outfitted containers long in advance of the need and/or with less inventory relative to the range of available configurations. This may be an advantage, for example, to a business providing water treatment equipment for rent, or to organizations that need to be able to respond quickly to emerging needs such as the military or a disaster relief agency. Alternatively, such a larger system may provide a means of providing an inventory of pre-assembled parts (i.e. shipping containers with common equipment and skids) that is able to quickly fulfill orders for a treatment system with selected skids, whether the treatment system is to be used permanently or temporarily.

Optionally, the system may include a first skid outfitted with educational equipment such as desks, chairs, monitors and controllers. System operators may occupy the first skid while receiving training on how to operate the equipment provided in a second skid. The second skid may be replaced by a third skid to facilitate training on how to operate a different kind of equipment.

The common equipment can include components or sub-systems that are frequently used with many types of water treatment. For example, the common equipment may include a water storage sub-system. The water storage sub-system may include a water storage tank. The stored water may be used, for example, to transfer water treated by one skid (e.g. filtrate) that will be treated further in a second skid. In another example, stored water is used for a cleaning process, such as backwashing or flushing equipment in a skid. The common equipment may also include, for example, a clean-in-place (CIP) sub-system. The CIP sub-system also stores water, but with the option of adding one or more chemical agents to the water. Different chemical agents may be added at different times. The chemically treated water may be used, for example, to clean equipment in a skid or to neutralize or otherwise treat a waste product. The common equipment may also include, for example, a compressed air supply sub-system. Compressed air may be used, for example, to activate valves of the common equipment or a skid, or to clean common equipment or equipment in a skid. Common equipment optionally includes systems not directly related to water treatment processes, for example heating, ventilation and air conditioning (HVAC) systems, lighting systems or a container floor drain system.

Common equipment may also include some electrical supply equipment. Optionally, the common equipment is adapted to be connected to an external power supply such as an electrical grid, a generator or a battery. The common equipment may include a main electrical panel. A skid may include a sub-panel and a plug-in connector to receive alternating current (A/C) and/or direct current (D/C) power from the main electrical panel. The sub-panel is connected to equipment requiring power on the skid, for example pumps, actuators or instruments. One or more transformers, converters or power supplies, to supply lower voltage or direct current power for example for sensors, actuators, controllers or variable frequency drives, are preferably part of the common equipment but may be distributed between the common equipment and the skids.

The common equipment may also include a control panel. The control panel includes a programmable device, for example a computer or a programmable logic controller (PLC), to operate the water treatment system. The control panel has a user interface that allows an operator to enter parameters indicating what type of skid (e.g. type of separation unit) is installed in each receiver of the shipping container. The user also enters or selects a connection type to indicate whether the skids will be operated in series or in parallel. For skids operating in series, a first skid may be designated as a pretreatment skid and a second skid may be operated as a polishing skid. The system may be configured such that particular receivers are designated for the upstream and downstream skid. Alternatively, the common equipment may be provided with pipes and valves adapted to have the upstream and downstream skids placed in any receiver, and the user enters into the control panel whether each receiver is upstream or downstream. The control panel is programmed with ladder logic that serves to control each skid type (e.g. MF, UF, RO, NF, MMF, GSF, GAC, IX etc.). The ladder logic (code) that is written for the skids that a user identifies as being present is activated while the other code is suppressed or unused.

Each skid contains a remote input and or output (I/O) device. The I/O device contains Input and/or Output cards that convey signals to and/or from skid components such as variable frequency drives, valves and instruments. The remote I/O device of a skid connects to the control panel of the common equipment for example via an ethernet cable. The ethernet cable allows the program from the control panel to communicate the ladder logic for a particular skid. The control panel also controls interactions between multiple skids that may be present with in the shipping container.

Hydraulic connections may be made between the common equipment and a skid by way of various unions, pipe coupling or pipe joining devices known in the art, optionally referred to generically as “couplers” herein. Optionally, pipes that extend between the common elements and a skid when connected may be parallel with the length of the shipping container at the coupling point with the ends of the corresponding pipes extending from the common equipment and a skid meeting at a predetermined location within the container. Couplers that accept some mis-alignment, such as Victaulic™ connectors, may be used. Alternatively, some or all of the pipes may have flexible segments such that precise positioning and alignment are not required.

Each skid may provide one or more of a variety of water treatment types. For example, a skid may include ultrafiltration equipment, reverse osmosis equipment, ion exchange equipment, media filtration, depth filtration equipment, green sand filtration equipment or activated carbon treatment equipment.

The shipping container has various fittings accessible from outside of the shipping container for bringing water into or out of the shipping container. For example, the shipping container may have one or more feed water inlets that may be connected to one or more skids. Depending on the configuration in use, one feed inlet may be temporarily capped (or otherwise unused) or both feed inlets may be connected together inside of the container. The container may also have a service water inlet. The service water inlet may be used, for example, to provide potable water for cleaning or drinking. The shipping container may also have one or more product water outlets. Depending on the configuration in use, one product water outlet mat be temporarily capped (or otherwise unused) or connected (from inside or outside of the container) to a feed water inlet. The shipping container may also have a process waste drain. The process waste drain may be used, for example, to remove filtration concentrate or other wastewater generated by a water treatment process under pressure. The container may also have a utility drain. The utility drain is available to be connected to a drain associated with a skid to remove wastewater generated in a skid that drains by gravity. The container may also have a floor drain. The floor drain is typically a standard component of the container and collects any water that falls to the floor of the container and may be considered common equipment. One or more, optionally all but for the floor drain, of these fittings may communicate with the skids by way of pipes and valves of the common equipment.

Connecting a skid to the common equipment may include: physical connection of the skid to a receiver or otherwise to the shipping container, for example via mechanical bolts; hydraulic connection of the skids' piping to the common equipment, for example via Victaulic™ couplings; power connection via a single electrical connection or separate A/C and D/C connectors; controls connection, for example via an ethernet cable; and, compressed air connection via a pneumatic coupling.

The figures show an example of a system. In this example, the system includes a shipping container with common equipment. The common equipment includes a water storage sub-system, a CIP sub-system and a compressed air supply sub-system. The system also includes two RO skids and two UF skids. The system may be configured to have one RO skid only, two RO skids, one UF skid only, two UF skids, or an RO skid downstream of a UF skid. Optionally, the system includes two shipping containers with common equipment. In this case, there are various permutations and combinations of water filtration needs in the field wherein both shipping containers may be deployed simultaneously. The flexibility of the system as a whole increases as the number of shipping containers with common equipment and the number of skids increases. Further, skids having different types of water filtration equipment, for example other types of membrane filtration (e.g. microfiltration and/or nanofiltration), media (e.g. sand) filtration, depth filtration, green sand filtration, ion exchange or activated carbon treatment, may be added to the system.

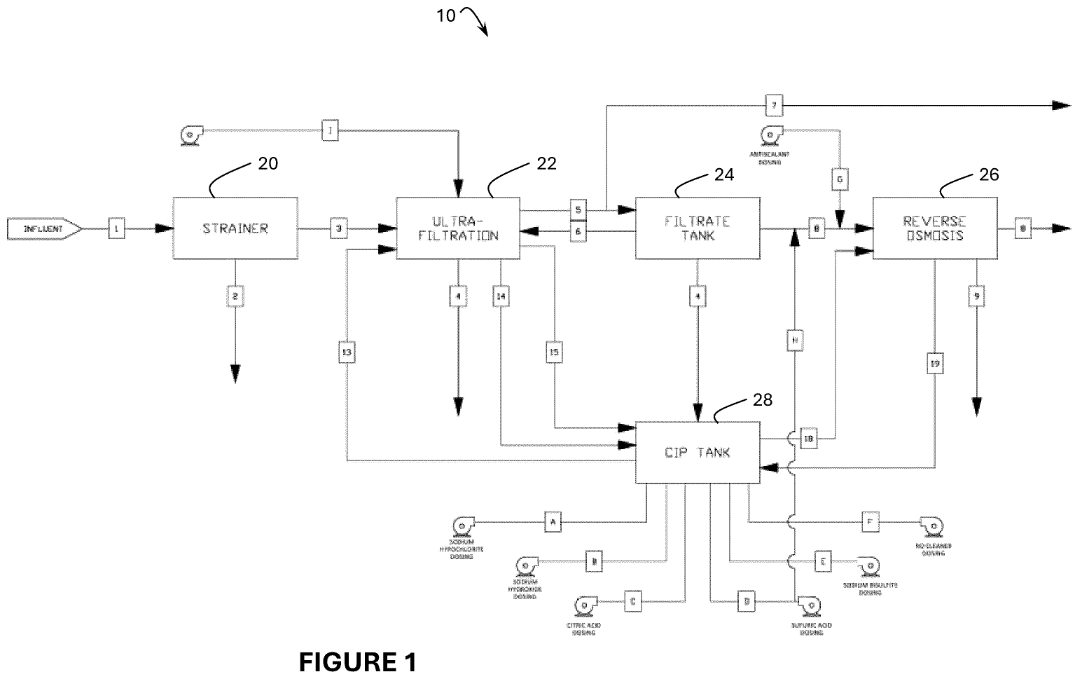

FIG. 1 shows available process flows in a mobile water treatment system 10 optionally configured to provide water treatment by way of two types of membrane filtration (e.g. microfiltration or ultrafiltration followed by nanofiltration or reverse osmosis). Physical components of the system 10 optionally include a strainer 20, UF modules 22, a filtrate tank 24, RO modules 26 and a CIP tank 28. Water streams optionally include influent 1, strainer waste 2, UF feed 3, UF backwash waste 4, UF filtrate 5, backwash water 6, UF filtrate for use 7, RO feed 8, RO concentrate 9, RO permeate 10, UF CIP supply 13, UF CIP return 14, UF concentrate CIP return 15, RO CIP supply 18 and RO CIP return 19. Other streams optionally include sodium hypochlorate dosing A, sodium hydroxide dosing B, citric acid dosing C, sulfuric acid dosing D, sodium bisulfite dosing E, RO cleaner dosing F, RO antiscalant dosing G, and UF air scour supply I. In some alternatives, the UF modules 22 and/or the RO modules 26 are replaced with other filtration modules such as other membrane filtration modules (e.g. microfiltration (MF) modules or nanofiltration (NF) modules), media filtration modules (e.g. sand filtration modules or mixed media modules), depth filtration modules, or green sand filtration modules. In some alternatives, the UF modules 22 or the RO modules 26 are replaced with other treatment modules such as sorption modules, e.g. granular activated carbon modules or ion exchange modules. The choice of whether to replace the UF modules 22 and/or the RO modules 26 with a particular alternative filtration or other treatment module may be made considering the treatment process desired. The water and other streams shown in FIG. 1 are an example of streams available in the mobile water treatment system 10 in the configuration shown and other streams may be provided in other configurations.

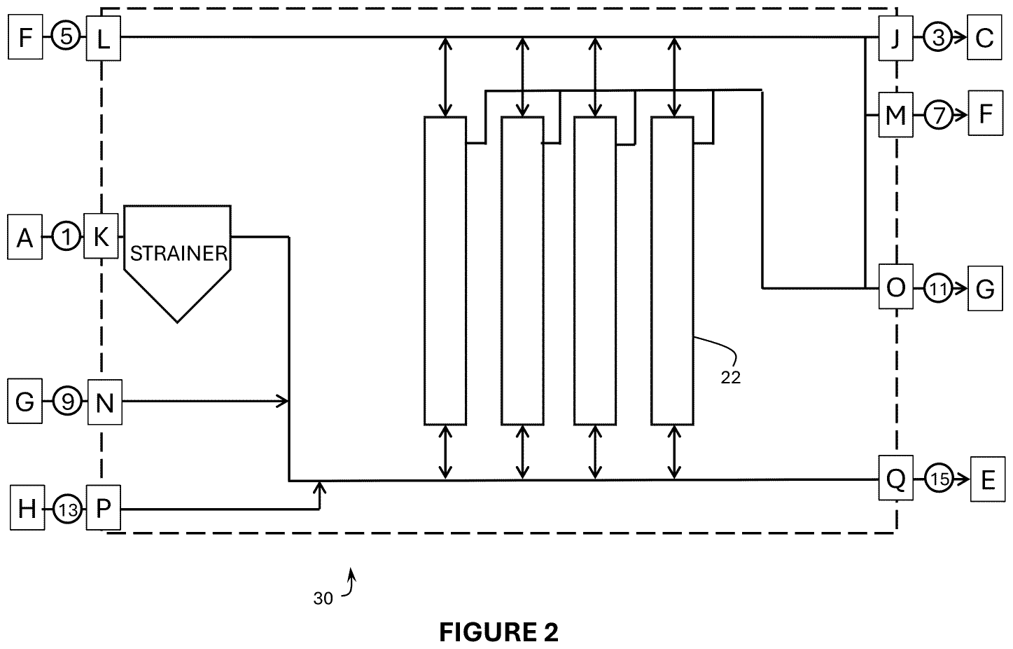

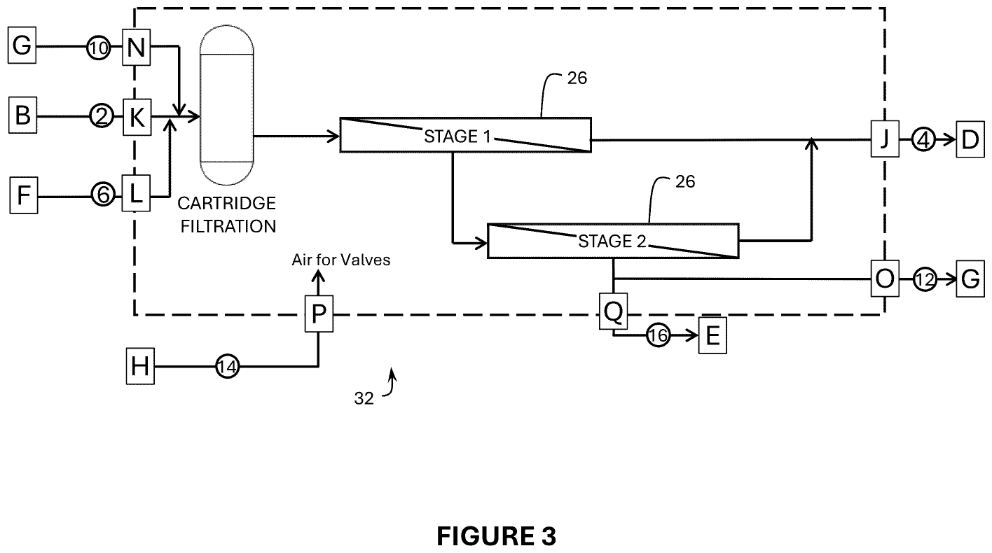

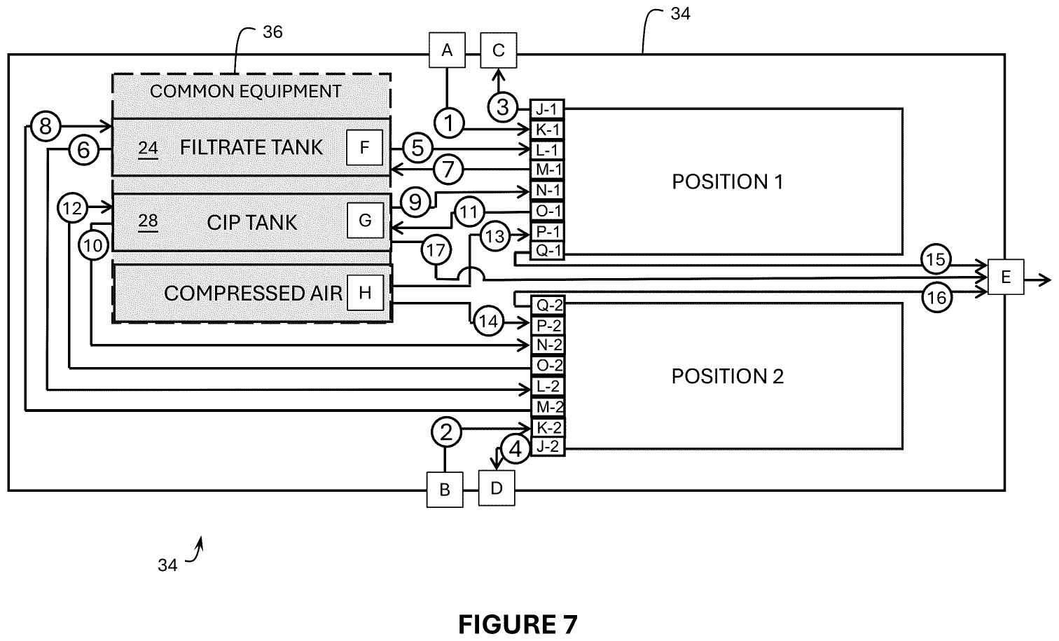

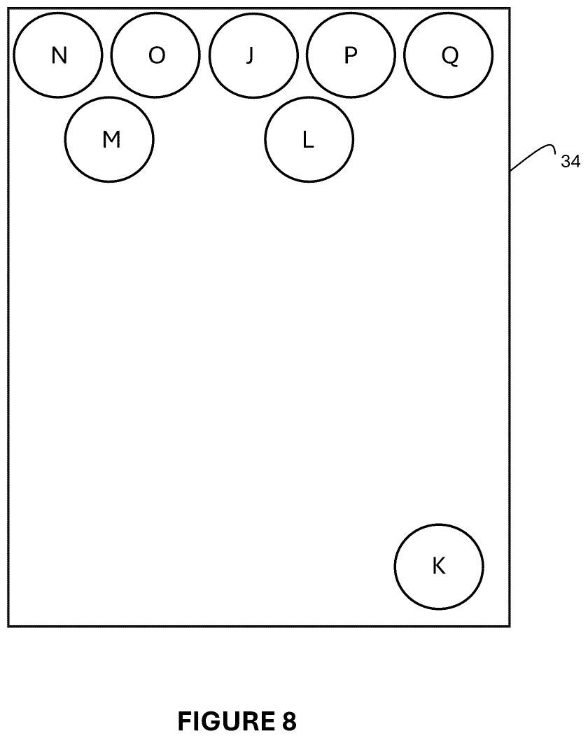

FIGS. 2 to 8 show additional aspects of an example of a mobile water filtration system 10. In this example, FIG. 2 shows a UF skid 30, FIG. 3 shows an RO skid 32, and FIG. 7 shows a container 34 with common equipment 36 and the UF skid 30 at position 1 and the RO skid 32 at position 2. To simplify the drawing, the skid at position 2 is shown schematically as a mirror image of the skid at position 1 in the sense that couplers J to Q are arranged from top to bottom in position 1 and from bottom to top in position 2. However, the arrangement of couplers J to Q in both positions is preferably the same, for example as shown in the cross section of FIG. 8, and the piping (including for example pipes 1 to 17) shown in FIG. 7 is modified accordingly. In this way, a UF skid 30 or an RO skid 32 (or other types of skids) may be used in either position 1 or position 2 without requiring left-hand and right-hand versions of the skids. To further simplify the drawings, pumps, valves and other flow control devices are not shown. For example, each pipe 1 to 17 may optionally have one or more valves, pumps or other flow control devices added to selectively provide flow in every direction indicated or otherwise required. The valves, pumps and any other flow control devices may be configured to provide a selected set of streams, for example the streams shown in FIG. 1.

Referring to FIG. 7, the container 34 has two feed water inlets, A and B, accessible through the wall of the container 34. The container 34 also has two product water outlets, C and D, accessible through the wall of the container 34. The container 34 also has a process water drain E accessible through the wall of the container 34. Although not shown, the container 34 may have other connections accessible through the wall of the container 34, for example a utility (i.e. gravity) drain, a floor drain and/or a service water inlet.

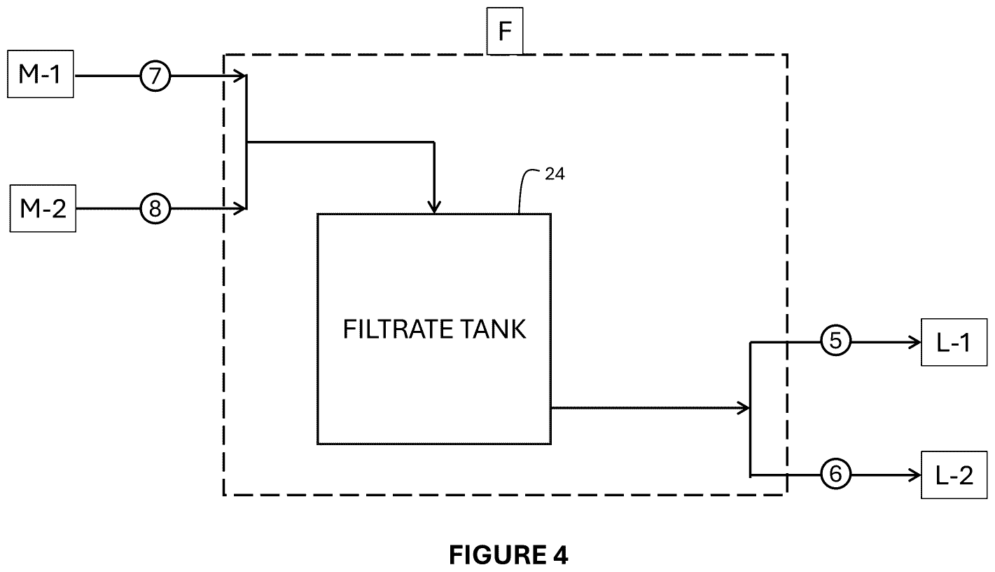

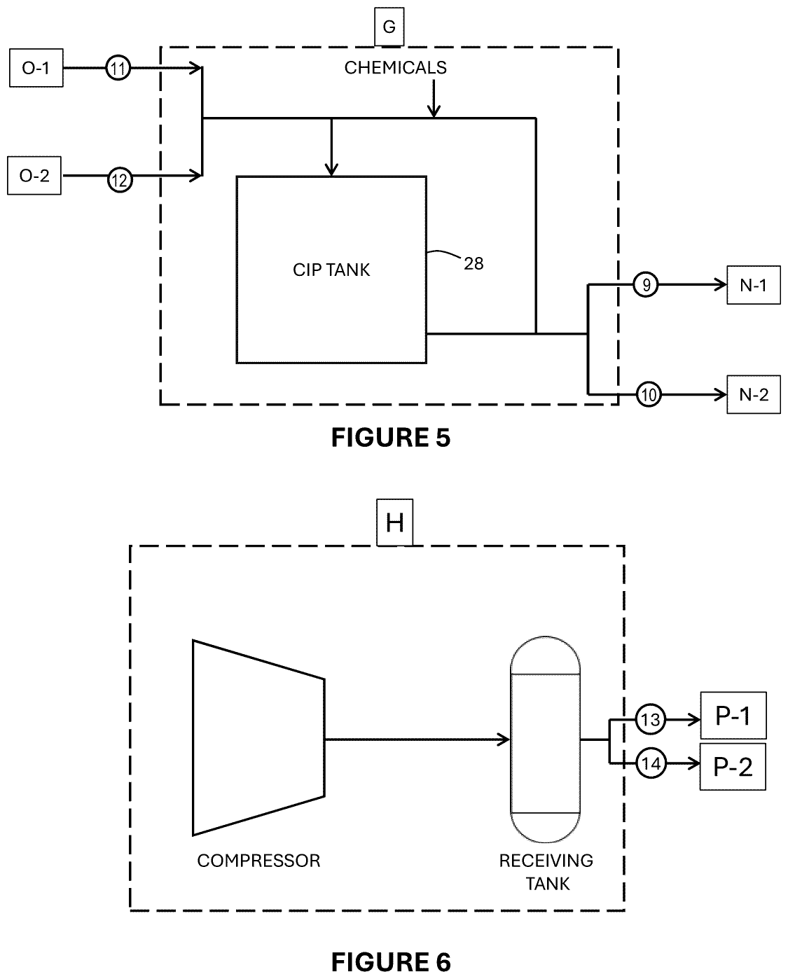

The container 34 also contains common equipment 36. In the example shown, the common equipment includes a water storage sub-system F, for example as further shown in FIG. 4; a clean-in-place sub-system G, for example as further shown in FIG. 5; and, a compressed air supply sub-system H for example as further shown in FIG. 6.

The sub-systems F, G and H of the common equipment 36 are shown having connections to two sets of couplers, indicated by the letters J to Q and the suffix “-1” or “-2”, of the mobile water treatment system 10. In contrast, the skids 30, 32 shown in FIGS. 3 and 4 each have connections (at the dashed line periphery indicating the boundary of the skid 30, 32) to one set of couplers indicated by letters J to Q without the suffix “-1” or “-2”. This is to indicate that each skid 30, 32 may be placed in either position 1 or position 2 of FIG. 7, i.e. with connections to the couplers indicated by letters J to Q with the suffix “-1” or to the couplers indicated by letters J to Q with the suffix “-2”. The couplers J to Q are shown in FIGS. 2 and 3 in arbitrary positions but are preferably located in the skids 30, 32 to correspond with the configuration of corresponding couplers of the container 34, for example as shown in FIG. 8.

The connections beyond the dashed line periphery indicating the boundary of the skid 30, 32 in FIGS. 2 and 3 to numbered pipes and the container connections or sub-systems A to H are according to an optional exemplary configuration whereby a mobile water treatment system 10 has the UF skid 30 at position 1 and the RO skid 32 at position 2, for example to provide a process flow as in FIG. 1. Optionally, other configurations may be used.

Referring to FIG. 2, an exemplary UF skid 30 is provided with ultrafiltration (UF) modules 22. In the example shown, the UF modules 22 include hollow fiber membranes configured for pressure driven outside-in filtration with periodic backwashing, air scouring, feed side flushing and/or deconcentration, and chemical cleaning. In the exemplary configuration whereby a mobile water treatment system 10 has the UF skid 30 at position 1 and the RO skid 32 at position 2, feed water is provided to the feed side of modules 22 from A through K. Filtered water is provided from a permeate side of the modules 22 to F through M and optionally periodically to G through O, but the paths to C through J is closed and the path to F through L is also closed during filtration. In alternate configurations where the UF skid 30 provides the final or only stage of treatment, the path to C through J is open. When required, backwash water is provided from F through L to the permeate side and optionally the feed side of modules 22, backwash air is provided from H through P, and water with cleaning chemicals is provided from G through N. Retentate, backwash and used cleaning solutions are discharged to E through Q. The exemplary UF skid 30 is configured for generally dead end filtration (optionally interrupted by backwash, air scouring, flushing, chemical cleaning or other feed side deconcentration or membrane cleaning events) through the modules 22. Modules with other types of membranes, e.g. microfiltration membranes, or other filtration media that may be used with a similar process may be substituted for the UF modules 22 (optionally with appropriate modifications for processes that do not require one or more of backwashing, air scouring, feed side flushing and/or deconcentration, and chemical cleaning).

Referring to FIG. 3, an exemplary RO skid 32 is provided with RO modules 26. In the exemplary configuration whereby a mobile water treatment system 10 has the UF skid 30 at position 1 and the RO skid 32 at position 2, the path from B through K is closed. The path from B through K is open in alternate configurations if RO skid 32 provides first stage treatment. Feed water in the configuration shown is provided from F through L. Periodically, chemical solutions are provided from G through N. Permeate is provided to D through J. Concentrate is provided to E through Q and optionally periodically to G through O. In the example shown, two RO modules 26 with concentrate staging are used. Optionally, various numbers of modules, forms of staging, or recirculation configurations may be provided. The exemplary RO skid 32 is configured to provide cross flow through a feed side of the modules. Modules with other types of membranes (e.g. nanofiltration (NF) membranes or ultrafiltration membranes, in spiral wound, hollow fiber or other configurations), that may be used with a similar process may be substituted for the RO modules 26.

Referring to FIG. 4, water storage sub-system F is part of common equipment 36 and has a filtrate tank 24. The term “filtrate tank” 24 is used for convenience in relation to the configuration of FIG. 1 and does not imply that this tank, which may alternatively be called a water storage tank, must always be used to hold filtrate. The filtrate tank 24 can selectively receive water from a skid in either position (i.e. position 1 or position 2 shown in FIG. 7). Water can also be selectively supplied to a skid in either position from the filtrate tank 24.

Referring to FIG. 5, CIP sub-system G is part of the common equipment 36 and includes a CIP tank 28. Chemicals, for example chemicals shown in FIG. 1, may be selectively added to the CIP tank 28 or to water flowing from the CIP tank 28. The CIP tank 28 can selectively receive water from a skid in either position. Water can also be selectively supplied to a skid in either position from the CIP tank 28.

Referring to FIG. 6, compressed air supply sub-system H is part of the common equipment 36 and includes a compressor and a receiving tank. Compressed air can be selectively supplied to a skid in either position from the receiving tank.

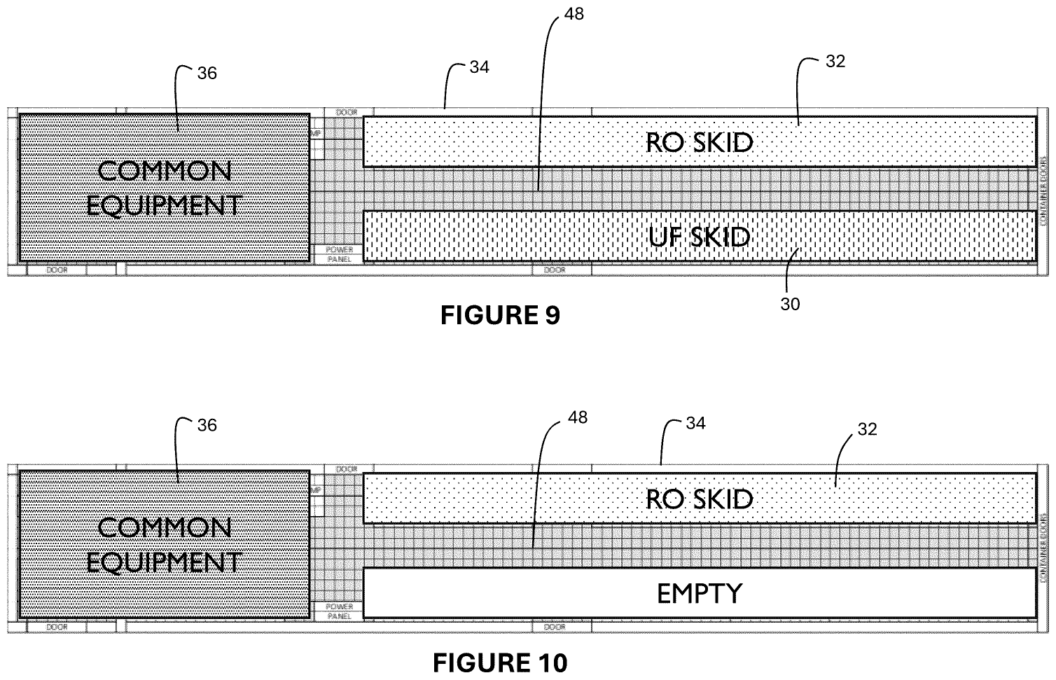

The mobile water treatment system 10 may be configured alternatively, for example as shown in FIGS. 9 to 13. In these configurations, pipes in skids 30, 32 may be opened or closed as required to provide process flows analogous to the process flows described above or otherwise appropriate from the skids 30 and/or 32 in use. In other alternatives, a skid having another type of treatment unit is used in place of skid 30 and/or skid 32.

Optionally, microfiltration, media filtration (e.g. sand filtration or mixed media filtration), depth filtration, green sand filtration or sorption (e.g. granular activated carbon or ion exchange) may be provided by replacing the UF modules 22 of FIG. 2 with vessels containing the appropriate media. In some cases, for example depth filtration and optionally granular activated carbon treatment, the ability to backwash might not be required and the appropriate pipes are closed. In the case of ion exchange, the backwashing and/or CIP systems and/or processes of an ultrafiltration module are modified to provide regeneration of the ion exchange media.

Optionally, nanofiltration or cross flow microfiltration or ultrafiltration can be provided by replacing the RO modules 26 of FIG. 3 with nanofiltration, microfiltration or ultrafiltration modules, or a mixture of membrane modules. Optionally, the RO modules 26 in FIG. 3 can be provided with alternative forms of staging of recycle, some of which may require additional pumps or other equipment, or according to other configurations known in the art.

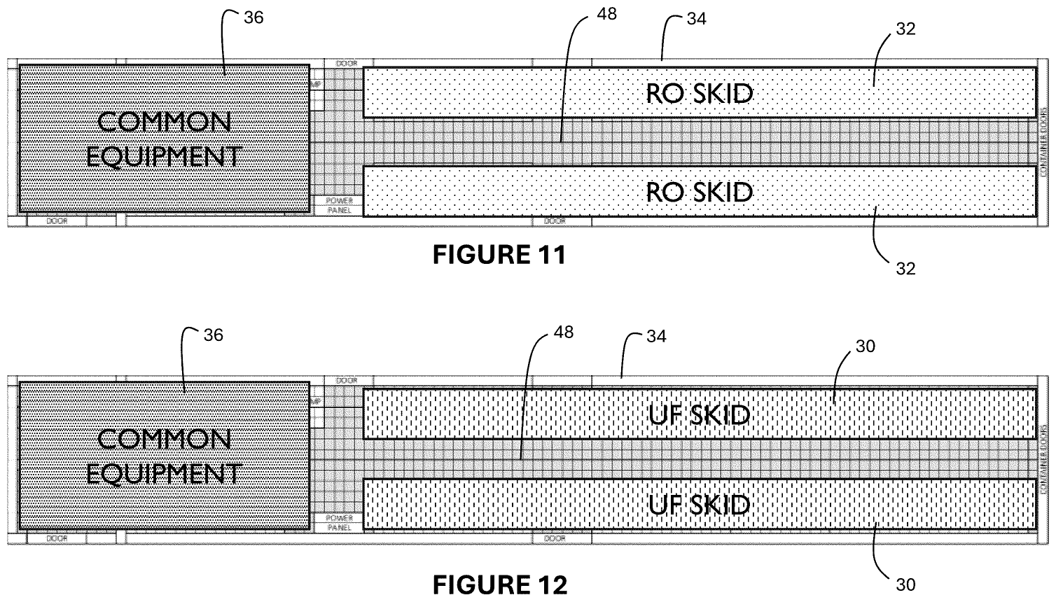

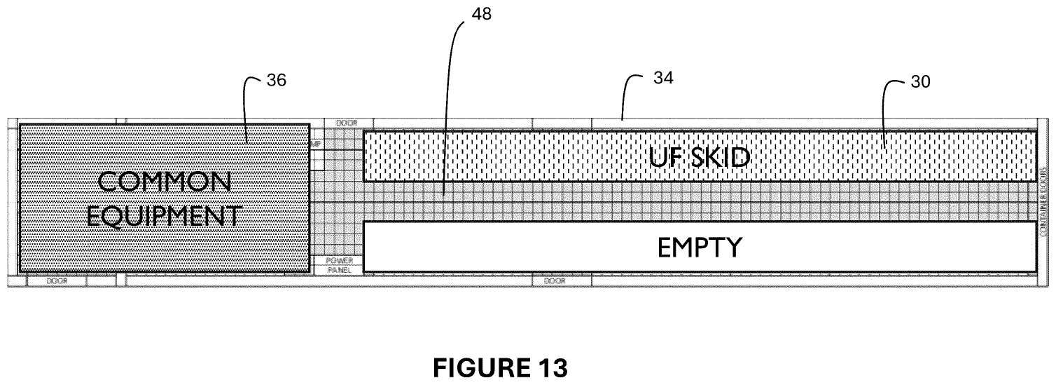

FIGS. 9 to 13 shows the mobile water treatment system 10 configured with various combinations of skids 30, 32. FIGS. 9 to 13 are schematic plan views showing the general layout of common equipment 36 and skids 30, 32 in a container 34. An aisle or walkway 48 is optionally provided between two skids and/or between skids and common equipment. As indicated for example in FIG. 9, the mobile water treatment system 10 can be used with two treatment skids optionally of different types in series, wherein the upstream skid may be in either position. As indicated for example in FIGS. 10 and 13, the mobile water treatment system 10 can be used with a treatment skid in only one of the positions with the other position left empty. As indicated in the examples of FIGS. 11 and 12, the mobile water treatment system 10 can be used with two treatment skids, optionally of the same type, operating in parallel. Appropriate changes to the connections and flow paths described in relation to FIGS. 2 to 7 may be made to facilitate the alternative configurations of FIGS. 9 to 13.

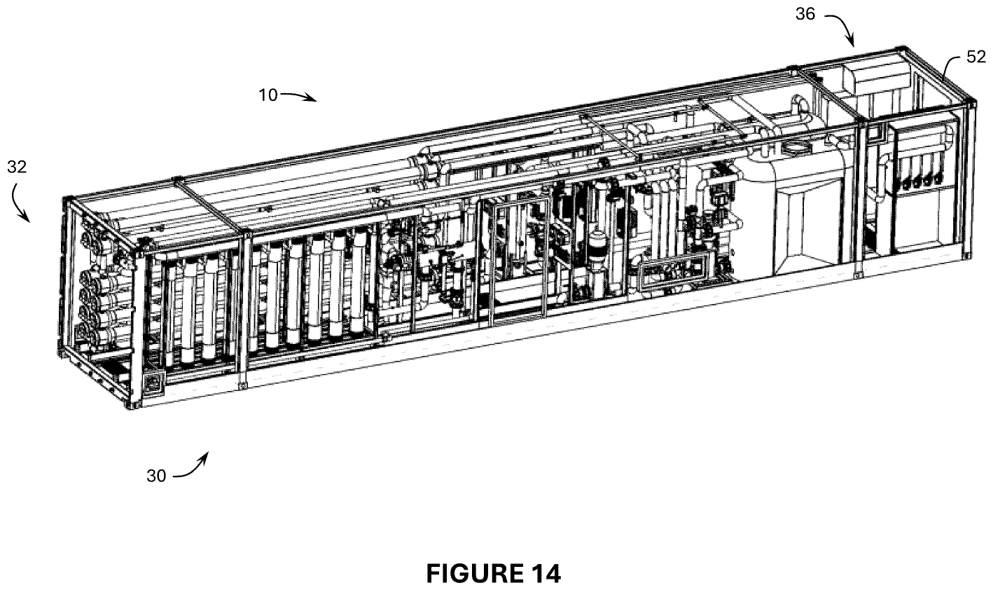

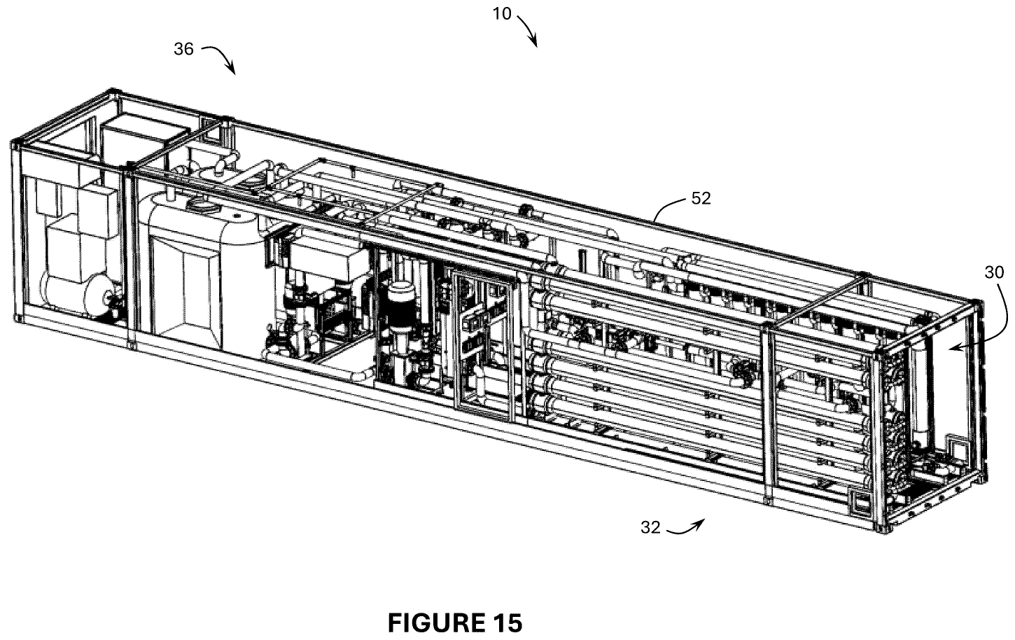

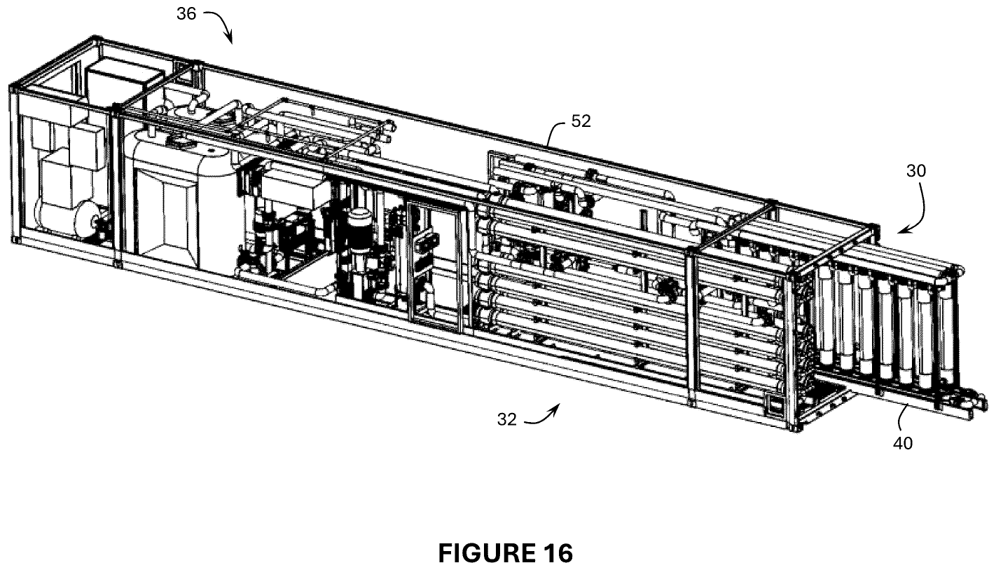

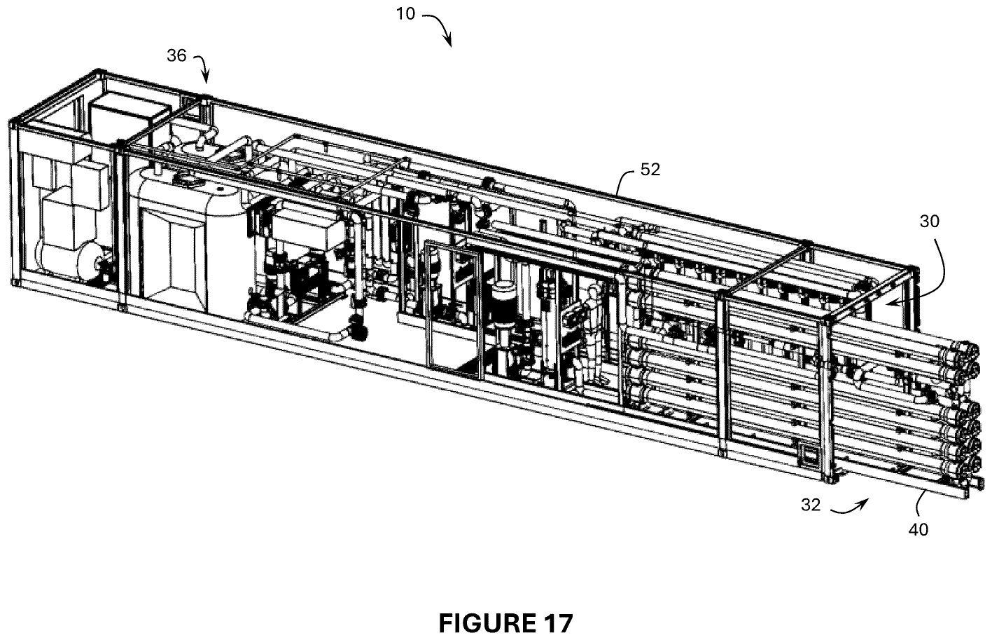

FIGS. 14 and 15 show a mobile water treatment unit 10 having common equipment 36, a UF skid 30 and an RO skid 32. The skids 30, 32 are inserted in a container. The container is represented in these figures only by container frame 52. The typical walls of a container were removed in the drawing to allow the components inside of the container to be seen. FIGS. 16 and 17 are similar drawings but with the UF skid 30 partially slid out of the container frame 52 in FIG. 16 and the RO skid 32 partially slid out of the container frame 52 in FIG. 17.

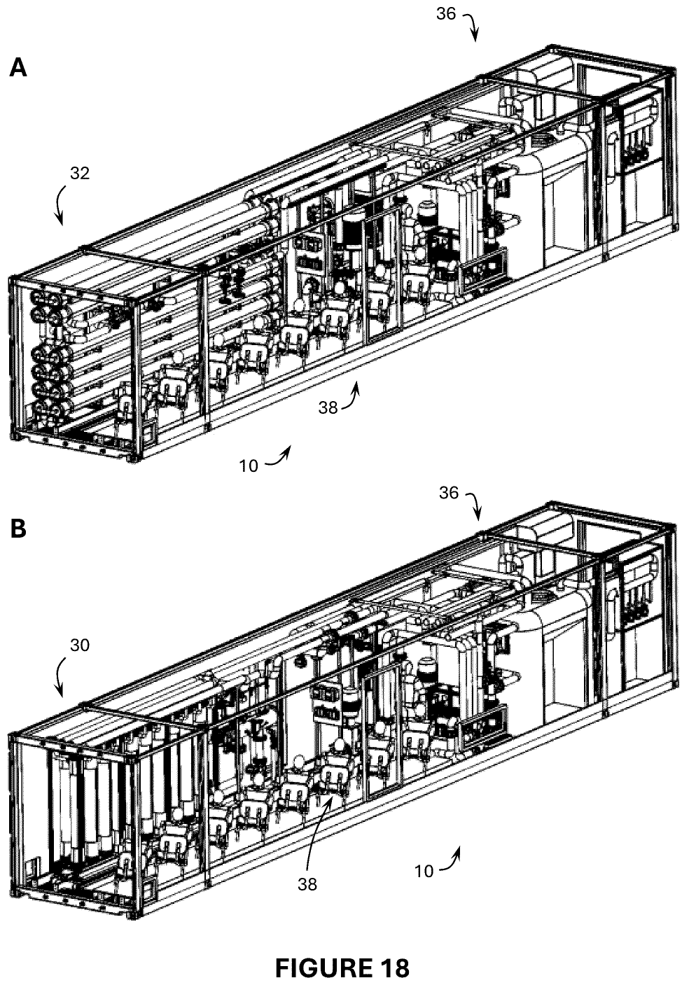

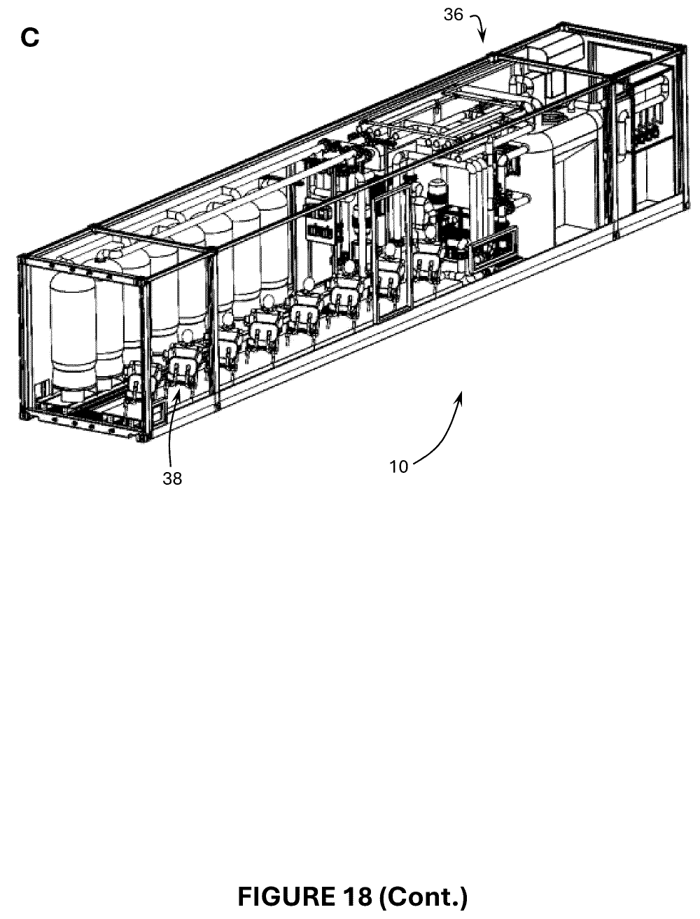

As shown in FIG. 18, a mobile water treatment system 10 may have educational equipment, optionally provided on a training skid 38. In panel A of FIG. 18, trainees are operating an RO skid 32. In panel B of FIG. 18, trainees are operating a UF skid 30. In panel C of FIG. 18, trainees are operating a sand filtration skid 50.

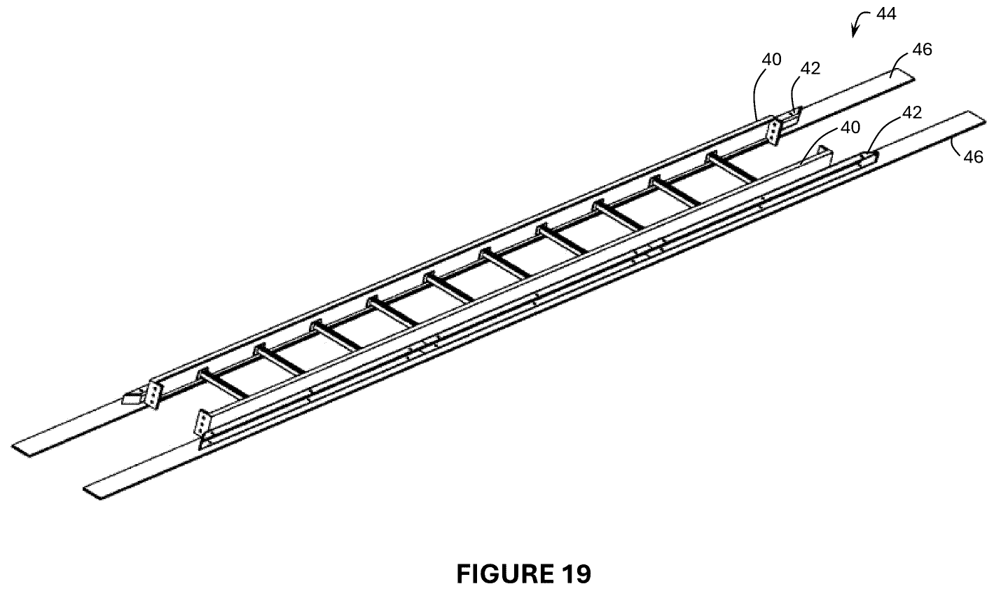

FIG. 19 shows a receiver 44 of a container 10. The receiver 44 shown includes one or more rails 46 which may be attached, for example bolted or welded, to the floor of the container 10 (not shown). Two rails 46 are shown in FIG. 19 but one alternative is to instead have a single rail extending from the left side of the left rail 46 to the right side of the right rail 46 as shown in FIG. 19. The one or more rails 46 may be, for example, pieces of flat steel. Optionally, the floor of the container may be a built-up floor that provides a drainage space under the one or more rails 46. The receiver 44 may also include optional guides 42. FIGS. 16 and 17 also shows frames 40 of, for example, skids 30, 32. The various components of the skids 30, 32 are attached to their associated frames 40. A skid 30, 32 (or other type of skid) can be inserted into a container by sliding its frame 40 on the receiver 44. For example, a frame 40 can be be pushed (e.g. with a fork lift, tractor or skid steer) and/or pulled (e.g. with a winch attached to the inside of the container 10) onto the receiver 44. Optionally, the frame 40 or receiver 44 may be fitted with rollers or low friction pads to decrease the force required to move the frame 40 along the receiver 44. Rollers, if used, are optionally removable. For example, one or more steel flanges with rollers may be fitted (e.g. bolted) to the frame 40 to permit rolling the frame 40 onto the receiver 44 and later removed when the frame 40 is in place. Optionally, a jack screw or other adjusting device may allow the rollers to be raised or lowered relative to the flange. However, merely lubricating the frame 40 and/or receiver 44 with grease may be sufficient to allow the frame 40 to be pushed and/or pulled onto the receiver 44. Optionally, once in position the frame 40 may be bolted or otherwise attached to the receiver 44 or the floor of the container 10 for shipping or while in use.
Optionally, a mobile water treatment system 10 may include other selections, permutations or combinations of one or more features described herein.

1. A water treatment apparatus comprising,
a shipping container;
common equipment mounted in a first end of the container; and,
two or more receivers extending lengthwise in a second end of the container.

2. The water treatment apparatus of claim 1 wherein each of the two or more receivers comprises a rail.

3. The water treatment apparatus of claim 1 wherein the common equipment comprises a water storage tank.

4. The water treatment apparatus of claim 1 wherein the common equipment comprises a tank in communication with a chemical doing system.

5. The water treatment apparatus of claim 1 wherein the common equipment comprises a programmable logic controller (PLC) wherein the PLC is encoded with operating programs for multiple water treatment operations.

6. The water treatment apparatus of claim 1 comprising two feed water inlets and two product water outlets.

7. The water treatment apparatus of claim 6 comprising an internal valved connection between one of the product water outlets and one of the feed water inlets.

8. A water treatment system comprising,
a shipping container having common equipment mounted in a first end of the container; and,
one or more water treatment skids,
wherein the shipping container selectively receives the one or more treatment skids within the container for connection to the common equipment.

9. The water treatment system of claim 8 further comprising a training facility skid.

10. The water treatment system of claim 8 comprising two or more water treatment skids.

11. The water treatment system of claim 10 comprising two water treatment skids each comprising the same type of separation unit.

12. The water treatment system of claim 10 comprising two water treatment skids each comprising a different type of separation unit selected from the group consisting of media filtration, ultrafiltration, reverse osmosis, ion exchange, activated carbon sorption, ion exchange and green sand filtration.

13. The water treatment system of claim 10 configured to connect two or more water treatment skids to provide sequential pretreatment and polishing treatment types.

14. The water treatment system of claim 10 configured to connect two water treatment skids in series to provide sequential treatment selected from the group consisting of, ultrafiltration/RO; media filtration/RO; media filtration/UF; RO/IX; ultrafiltration/GAC; and, green sand filtration/RO.

15. The water treatment system of claim 8 wherein the common equipment includes valves and pipes configurable to connect two water treatment skids in series or parallel.

16. The water treatment system of claim 8 wherein the common equipment includes a water storage tank.

17. The water treatment system of claim 16 wherein the common equipment includes valves and pipes configurable to connect two water treatment skids in series through the water storage tank.

18. The water treatment system of claim 8 wherein the common equipment comprises a PLC wherein the PLC is configured with operating programs for the one or more water treatment skids.

19. The water treatment system of claim 18 wherein the PLC is configured for user input of a treatment type parameter for the one or more water treatment skids.

20. A method of providing a mobile water treatment unit comprising,
providing a shipping container having common equipment mounted in a first end of the container;
placing one or more selectable treatment skids in a second end of the container; and.
connecting the one or more treatment skids to the common equipment.
